(19) United States
(12) Patent Application Publication
(10) Pub. No.: US 2009/0071824 A1
(43) Pub. Date: Mar. 19, 2009

(54) Integrated Sensing Array for Producing a BioFingerprint of an Analyte

(76) Inventors: Andrew D. Hibbs, La Jolla, CA (US); Regina E. Dugan, Rockville, MD (US); Michael Andrew Krupka, San Diego, CA (US)

Correspondence Address: DIEDERIKS & WHITELAW, PLC, 12471 DILLINGHAM SQUARE, #301, WOODBRIDGE, VA, 22192, US

(21) Appl. No.: 11/664,992

(22) PCT Filed: Oct. 14, 2005
(86) PCT No.: PCT/US2005/036142

§ 371 Date: Apr. 10, 2007

Related U.S. Application Data
(60) Provisional application No. 60/618,259, filed on Oct. 14, 2004.
(60) Provisional application No. 60/625,721, filed on Nov. 8, 2004.

(51) Int. Cl. G01N 27/26

(52) U.S. Cl. 204/403.06; 204/403.01

(57) ABSTRACT

An integrated array of electronic sensing elements outputs a bio-fingerprint of an analyte. System is preferably constructed of as a series of three layers but need not be so arranged. An upper layer defines a fluid volume or analyte chamber; a middle layer contains the sensing elements; and a third layer contains electronic readout elements. The analyte chamber contains an electrolyte and the analyte to be detected. The sensing elements are optimized for maximum detection sensitivity in the minimum response time. The response of each sensing element is read out by a dedicated sensing electrode. Around each electrode is a control ring. The potential of the control ring is set to attract analytes of interest to the sensing elements.

### CROSS-REFERENCE TO RELATED APPLICATIONS

This application claims the benefit of U.S. Provisional Application Ser. No. 60/618,259, filed Oct. 14, 2004 entitled “Integrated Sensing Array to Obtain a Biofingerprint,” and U.S. Provisional Application Ser. No. 60/625,721, filed Nov. 8, 2004 entitled “Suspended Membrane Sensing Array.”

### STATEMENT REGARDING FEDERALLY SPONSORED RESEARCH AND DEVELOPMENT

This invention was made was developed under contract DAMD 17-03-C-0085 awarded by the Defense Advanced Research Projects Agency (DARPA). The Government has a fully paid up non-exclusive license in this invention.

### BACKGROUND OF THE INVENTION

1. Field of the Invention

The present invention pertains to the art of identifying biological entities and, more particularly, to an integrated array of electronic sensing elements that outputs a bio-fingerprint of an analyte.

2. Discussion of the Prior Art

Rapid identification of very small concentrations of a range of molecules is important for many areas of science and technology. Promising methods include electrical recordings of arrays of cells, molecular receptors on surfaces with associated reporter molecules, and fluorescence based techniques. However, present sensing architectures require highly specific receptors (e.g. antibodies) that are difficult to assemble, expensive and are limited by noise from non specific binding events, and further suffer from the property that as sensitivity is increased, selectivity is compromised leading to false identifications.

The use of an array of partly specific single molecule sensing elements provides a way to produce a biofingerprint from a very small number of target molecules. Initial work included the use of non-biological tubes to act as a filter to detect a single molecule. Martin et al, developed small gold nanotubes in an attempt to measure the current produced by sufficiently small single molecules entering the tube and decreasing the flow of electrolyte ions flowing under an applied voltage. The tubes were on the order of tens of nanometers. While they were small enough in diameter to detect a single molecule, the length of the tube would allow more than one molecule in at a time, thus, preventing single molecule detection.

Bayley used engineered biological protein pores to bind to a single molecule. The small size of the pore allows only one molecule to enter at a time, while engineered covalently linked sensing moieties enable a range of molecular binding responses over a class of analytes. As an analyte molecule is captured, a characteristic time interval and decrease in current in the pA range can be measured. While this work has made great progress towards a biosensor, work in the electronic readout method and stability of the bilipid membrane is crucial for the success of this type of biosensor. In addition, a system capable of putting multiple pores in an array is needed to increase the accuracy, level of sensitivity and range of use for this application.

One of the major deficiencies in this area to date is the electronic readout methods available. Current methods such as the current gold standard, patch clamp, uses a DC method and resistive electrodes to make measurements. Due to gigaseal requirements this makes an array extremely cumbersome and not a viable option for the array system needed for this type of sensor. An array is necessary in order to allow for multiple sensing elements to capture multiple analytes at a single time. In addition, it could decrease response time and increase accuracy if several sensing elements are designed to detect the same analyte.

Another method of electronic readout is the Electrochemical Impedance Spectroscopy. This method uses data in the frequency domain to model an equivalent circuit. This system's major flaw is that it cannot measure the current signals in the time domain. This information is critical for using the protein pore method and single molecule detection. The current signal for the protein pores discussed above are on the order of pA and the duration is around 5 ms. Thus, time domain measurement is critical for seeing these events. The system proposed would use an AC readout method to be able to clearly see these events and thus allow for greater sensitivity and faster response time.

An additional critical problem with current methods revolves around the bilipid membrane. As many groups have shown, bilipid membranes are able to be placed on a substrate spanning a hole and allow for a protein pore to insert. However, these membranes are extremely fragile and sensitive to any vibration when spanning a large hole, greater than a few microns. This feature makes a robust system difficult. However, a method to decrease the size of the hole that the membrane spans could greatly increase the lifetime of the membrane, perhaps indefinitely. In addition, a system that is able to span a membrane over these small holes, on the order of 20 nanometers, and maintain the necessary gigaseal resistance would be crucial for the array design we propose. In addition, use of these smaller membranes would benefit the sensitivity of the system as well.

Other groups have attempted to increase the stability of the bilipid by tethering it to a gold electrode. However, no work has shown a current measurement resulting from a protein pore inserting into the membrane and being measured by an electrode below. In addition to a lack of an effective readout system, the tethered membrane is subject to rapid Nersnt potential effects due to the small volume that is between the membrane and the electrode. In order to make this technology viable, a means of reducing these potential effects is necessary. If the current system uses this technology, it has an innovative method of an AC pore current to reduce these Nernst potential effects. In addition, a method to put this design into an array would further the usefulness of this technology.

While groups have managed to decrease the size of the membranes down to the micron level and experiments have described the use of submicron electrodes, the overall size of the apparatus used to date is on the scale of centimeters. One important feature of sensing the activity of a single sensing channel or pore is that the dimensions of the fluid chamber that holds the analyte solution of the sensing system can, in theory, be reduced to the submicron scale. Assuming a fixed amount of analyte available, the sensing system's sensitivity is inversely proportional to the volume of analyte required for an experiment. Thus, a critical question is how small can the analyte volume be made?

One example of a system trade-off is the spacing between sensing channels or units in an array where a single analyte chamber is used to cover all the sensing units. In this case, the smaller the array spacing, the smaller the volume of the analyte chamber, and so the smaller the amount of the analyte that is needed. However, at some point, reducing the center-to-center spacing between the sensing units requires a reduction in the size of the sensing units themselves. Reducing the size of the sensing units reduces the time the system can operate before Nernst potential related concentration effects arise. While some compensating measures can be taken, such as reversing the sign of the ion flow in the system, they add system complexity. Overall, setting the size of the sensing unit array and the spacing between sensing units is a complex matter that involves a trade-off between many competing effects.

Another system trade-off is that between the sensitivity of the system and the response time. The higher the sensitivity of the system, the longer it takes for a positive response to occur or to be assured of a negative response. For example, if the response time for an analyte concentration of 1 nM would be 1000 times faster than the response time for an analyte concentration of 1 pM. Thus, critical determinations based on application must be decided on creating a balance between sensitivity and response time. In addition, proposed corrective measures such as decreasing the sample volume can increase the effective concentration in the system, thus decreasing the response time while still increasing the sensitivity.

Further complications arise from fabrication of a membrane sensing system. Biological membranes and protein pores require careful and precise control of physical conditions in order for the former to be formed and the latter to be inserted. In the event that an artificial membrane is used, insertion of the pore is still a complex process that requires the use of well-controlled fluid bodies, as well as electric potentials and fields. The smaller the overall size of the systems, the more difficult it is to control these parameters, and the more difficult the fabrication of the membrane sensing system.

Interpretations of a system mediated by changes in membrane capacitance or by changes in the ion flow through a channel or pore in the membrane relies on a priori knowledge of the membrane, channel or pore associated with each sensing unit. Previous methods of accomplishing the directed insertion of a particular protein pore in a particular sensing unit have required sequential insertion of individual protein pores or types of protein pores and/or complex microfluidic systems employed to address individual sensing arrangements. This requirement extends to any sensing unit. Such techniques are complex both from system manufacturing and system assembly perspectives.

Based on the above, there exists a need for a system that incorporates an array of membrane and pore-sensing units in a manner that minimizes the amount of analyte required, while allowing the system to be fabricated at a reasonable cost. Furthermore, there exists a need for an array of membrane and pore-sensing units which is adapted to measure single analytes or multiple analytes simultaneously to create a biofingerprint.

### SUMMARY OF THE INVENTION

The present invention is directed to enabling discrete sensing elements that measure the presence of single molecules to be incorporated into an array optimized for maximum detection sensitivity in the minimum response time.

An array of sensing elements is located within an analyte chamber. The response of each sensing element is read out by a dedicated sensing electrode. The system is most easily constructed and conceived of as a series of three layers, but need not be so arranged. An upper layer defines a fluid volume or analyte chamber. A middle layer contains the sensing elements, and a third layer contains the electronic readout elements.

The analyte chamber contains an electrolyte and the analyte to be detected, if present, and any interfering chemical species. In general, the analyte is collected from the environment or source of interest and reduced to aqueous form by various known ways not specific to the invention.

The sensing elements are in contact with the analyte chamber. The sensing elements comprise a sensing chamber separated from the analyte chamber by a thin barrier. Penetrating the barrier is a small hole that allows a current of electrolyte ions to flow under a suitable applied voltage. Preferably, molecular specific receptors are placed within the holes to modulate the electrolyte current in the presence of a specific molecule. However, for some analytes and applications, the blocking effect alone due to the presence of a specific molecule within the hole may produce an adequate signal. Further it should be appreciated that a change in the conductance of the barrier itself or insertion of a protein pore into the barrier that is directly mediated by the analyte, can result in a change in electrolyte current into the sensing chamber, and are thus possible detection mechanisms. For convenience these current modulating entities and mechanisms will be herein after grouped under the term “pore”.

Within the array, each sensing element is designed to have a level of specificity to an analyte of interest. Depending on the nature of the sensing element, the specificity can range from a response to only one analyte, to responding to a class of analytes, or to responding to an interferent and not the analyte of interest. The response is a natural property of the pore or may be engineered into it. The output of the array provides a fingerprint of the analyte or group of analytes present in the analyte chamber. The individual sensing element outputs may be combined by suitable algorithms to produce an optimized response to one or more target analytes.

There are two paradigm barrier configurations. The suspended configuration in which the barrier spans an orifice over a larger volume, and the supported configuration, in which the barrier is in continuous contact with a polymer or aqueous support that is compatible with incorporation of and functioning of the pore. The case of a simple orifice in a solid material with no membrane or pore is a subset of the suspended configuration with the solid material defining the orifice in general being thin and covering a relatively large lateral distance to define the sensing chamber volume.

Preferably, the barrier of the sensing element is comprised of a biologically compatible thin membrane such as a bilayer lipid membrane (BLM) or a membrane made from polydimethylsiloxane (PDMS). A protein pore, such as alpha hemolysin or maxi K, is incorporated into the membrane although other ion channels, transporters, or other suitable biological entities could be used. In both suspended and supported cases the membrane is in general larger than the sensing chamber of the sensing element and the pore must be introduced and/or constrained to stay in the required location with in the membrane.

The response of the pore is to modulate the electrolyte current through it into its associated sensing chamber in response to a target analyte. In some cases the sensing chamber is defined by a volume etched or otherwise fabricated in a solid material. In other cases the upper, lower and edge boundaries of the sensing chamber are formed by different materials, such as a bilayer lipid membrane, a silicon wafer and a polymer respectively. The electrolyte current is measured via an electrode coupled to the electrolyte in the sensing chamber. The total thickness of the sensing chamber and its specific embodiment depend on the barrier configuration and the overall construction of the sensing element. To minimize the volume of analyte needed in the analyte chamber, the sensing elements must be as close together and as small as possible. To minimize cross talk, the sensing electrode impedance to other array elements and to the analyte chamber must carefully controlled.

Given the need for a compact system, it is convenient to fabricate the electrodes using standard microfabrication techniques on a silicon, glass, or some other convenient substrate. Depending on the specific design of the sensing elements, the electrodes are built into the sensing layer or fabricated on the bottom surface of the analyte chamber. If desired one or more active amplification devices (e.g. transistors) are fabricated within the overall structure within close proximity to the associated sensing electrode.

Around each electrode is a control ring fabricated on the electronics layer or fabricated in the immediate vicinity of the barrier on the upper side of the sensing layer. The potential of this ring is preferably set to minimize the response time of the system by applying an appropriate voltage to attract analytes of interest to the sensing elements. Additionally false alarm performance may be improved by repelling interfering species. Also, the potential of the ring may be controlled by feedback to minimize coupling of the sensing electrode to stray potentials to improve sensitivity. A further use of the control ring is in the final stages of assembling the system, wherein the potential of the ring is set to attract or repel specific pores thereby enabling a specific type of pore to be directed to specific elements of the array. To do this the pore is tagged with a charge group in the manner known to those skilled in the art. Once the pore is inserted a DC potential is applied to the ring to anchor the pore within the membrane.

In order to make the volume of the sensing chamber as small as possible, it is necessary to control the ionic concentration in it. Two effects must be addressed. Firstly a buildup in the concentration of a specific ion (e.g. K⁺) relative to the analyte chamber leads to a Nernst potential across the barrier and pore. Secondly, for a capacitive electrode, the charge of the ions carrying the current is neither exchanged at the electrode nor cancelled by further ion liberation at the electrode and so there is a buildup of the net charge associated with the ions, leading to an associated voltage with respect to analyte chamber (i.e., across the pore). For a small sensing element, the capacitance of the sensing chamber is dominated by the capacitance of the barrier and sensing electrode. As a result, although different sensing element configurations are expected to have widely different sensing chamber volumes, they have substantially the same capacitance.

Capacitive electrodes coupled to an AC pore current can be used to address the problems associated with Nernst potentials and quasi-electrostatic voltages. In addition to reversing the pore current direction at frequencies much lower than the pore signal frequency as taught in international patent application PCT US2005/026181 entitled “Method and Apparatus for Sensing a Time Varying Current Through an Ion Channel” filed Jul. 22, 2005, it is also possible to drive the pore current at frequencies much higher than the pore signal frequency and then to recover the time dependence of the pore signal by demodulating this carrier frequency. These two techniques enable measurement of the pico-ampere variations of the pore current signal in the domain with a temporal resolution in the order of 0.1 ms.

In addition, although capacitive sensing electrodes are preferred because of their improved stability due to their lack of electrochemical reaction with the electrolyte, in some cases it is also beneficial to incorporate a resistive electrode in the sensing volume and a resistive reference electrode in the analyte volume. Such an electrode provides a DC voltage reference for the electronics used to amplify (read out) the potential of the sensing electrode and provides a means to limit the buildup of DC potential across the pore. Further, in cases in which a long operational lifetime for the array is not important, it is possible to use a sensing electrode that makes a resistive electrical connection to the electrolyte.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 schematically depicts a sensing system incorporating sensing elements for measuring the bio-fingerprint of an analyte according to a preferred embodiment of the invention;

FIG. 2 schematically depicts a sensing element of FIG. 1 in a suspended membrane configuration;

FIG. 3 schematically depicts a sensing element of FIG. 1 in a supported membrane configuration;

FIG. 4 schematically depicts a sensing element of FIG. 1 in a suspended membrane configuration using an orifice in a solid material;

FIG. 5 shows the sensing system of FIG. 1 with a reference electrode;

FIG. 6 is a graph showing a pore current as a function of time for different sensing chamber volumes;

FIG. 7 is circuit diagram showing an example of a circuit that modulates the pore current at relatively high frequency and then measures the change in the current that flows depending on pore resistance;

FIG. 8 is a graph showing a simulated signal of the current modulation generated by the circuit of FIG. 7;

FIG. 9 is a graph showing the simulated signal of FIG. 8 after being demodulated and processed by a 4-pole Bessel low-pass filter;

FIG. 10 shows a sensing element of a suspended configuration of the present invention with a control ring;

FIG. 11 shows a sensing element of a suspended configuration of the present invention with a control ring;

FIG. 12 shows a suspended membrane sensing system of the present invention wherein a sensing chamber is connected via a narrow interchamber channel to a fill chamber;

FIG. 13 shows multiple sensing chambers in an array;

FIG. 14 shows a diagram of a model of a circuit used to calculate dynamic system response in the present invention;

FIG. 15 is a graph showing a modulated input signal measured at point B of the circuit in FIG. 14;

FIG. 16 is a graph showing a calculated equivalent voltage noise for all components when a pore is in an open state (Rp=1 GΩ);

FIG. 17 shows an underlayer defining a sensing chamber in the supported configuration;

FIG. 18 shows the sensing chamber of FIG. 17 with an additional insulating layer; and

FIG. 19 is a graph showing system sensitivity assuming a separation of 50 μm, and 25×4 sensing units in an array for a 1 nM analyte.

### DETAILED DESCRIPTION OF THE PREFERRED EMBODIMENT

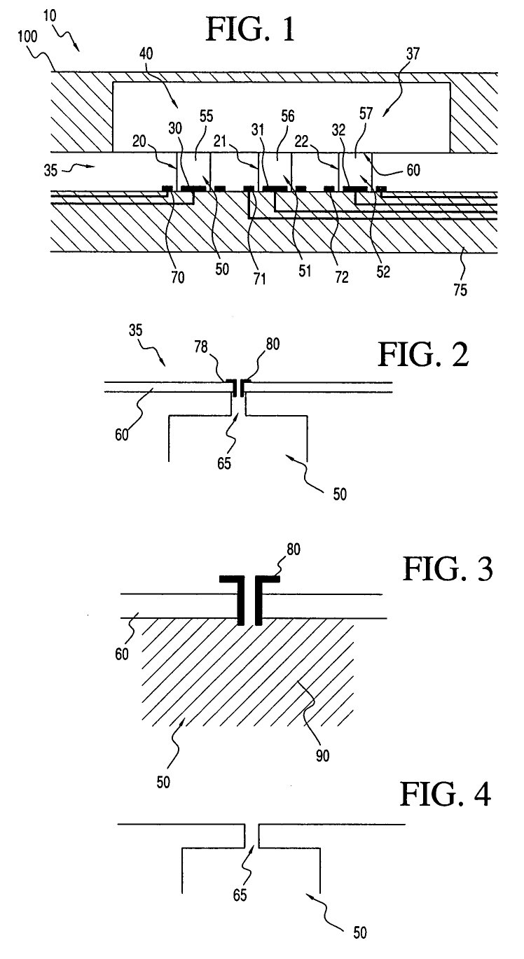

Referring to FIGS. 1-4, a system 10 is generally shown with sensing elements 20, 21 and 22 each having a sensing electrodes 30, 31 and 32 respectively which form a sensing layer 35. The elements may be arranged in an array 37. An analyte chamber 40 is formed above sensing layer 35. Sensing electrodes 30, 31, and 32 are located in sensing chambers 50, 51 and 52 respectively. Each chamber 50, 51, 52 has contains a sensing volume 55, 56, 57 of an electrolyte. A barrier or membrane 60 covers an orifice 65 located in sensing chamber 50 and also extends over the other sensing chambers 51 and 52. Around each electrode 30, 31, 32 is a control ring 70, 71, 72. Sensing elements 20, 21 and 22 are made up of three layers: an electronics layer 75; sensing layer 35 that includes sensing element 20 and membrane 60 having a central region 78 with a pore 80 located therein; and a fluidics layer 100. Electronics layer 75 and sensing layer 35 are preferably constructed in different substrates and bonded together at a convenient point in the fabrication of system 10. Fluidics layer 100 can also be separately constructed or assembled on top of sensing layer 35. Constructing system 10 of these individual layers 35, 75 and 100 provides a level of modularity and manufacturing convenience, but the invention is not limited to individual layers and may be constructed as a single substrate if desired. It is anticipated that in most cases membrane 60 will be fabricated in situ using fluids introduced into analyte chamber 40. Similarly, pore 80 will be inserted into analyte chamber 40 and will self-insert or self-assemble within the membrane 60.

The system as taught by the invention is preferably used with either of two paradigm barrier configurations, suspended and supported. As discussed in more detail below, the only significant difference between systems using the alternate configurations is that while having approximately the same area sensing chamber 50 is much deeper for the suspended configuration, and that a fluid access line and a fill line, is needed to fill sensing volume 55 of the suspended configuration, as discussed below. The choice of whether to use the suspended or supported configurations depends on a number of factors including the analyte(s) of interest, the environmental interferents, the required system robustness and the desired sensitivity. As scientific progress continues in this field, the relative merit of the two configurations is likely to change. Thus, in the preferred embodiment, system 10 is able to accommodate both of the alternative barrier configurations.

With reference to FIGS. 2 and 3, the suspended and supported configurations are shown respectively. In the preferred embodiment, system 10 comprises membrane 60, such as a bilayer lipid membrane, sealed over sensing chamber 50 in sensing layer 35. Membrane 60 is preferably continuous such that membrane 60 covers all elements 20, 21 22 of array 37, or a set of smaller membranes (not shown) covering one or more sensing chambers 50, 51, 52 are used. Up to five pores 80 are in region 78 of membrane 60. Pore 80 may be a protein pore, ion channel, transporter or other such entity.

Associated with each sensing volume 55, 56, 57 is region 78 of membrane 60, generally centered over sensing chamber 50, 51, 52, where pore 80 must be located for correct operation. Pores 80 become located in region 78 either by diffusion or guided by electrophoretic or electroosmotic forces, until they reach the correct position. The sticking force is preferably electrostatic due to applied electric fields or pore 80 may be bound by an anchoring molecule (not shown).

In normal operation, the electrolyte containing dissolved analyte and interfering species, if present, is passed into analyte chamber 40 and remains in chamber 40 for a time period sufficient to give a high statistical likelihood that an adequate number of analyte capture events will occur; that is, an adequate number of pores 80 will be engaged by analyte molecules. Next, the electrolyte medium is replaced with a fresh electrolyte medium/analyte. Thus, the electrolyte in analyte chamber 40, and in general system 10, is repeatedly reset to its starting concentration on a time scale on the order of minutes or less.

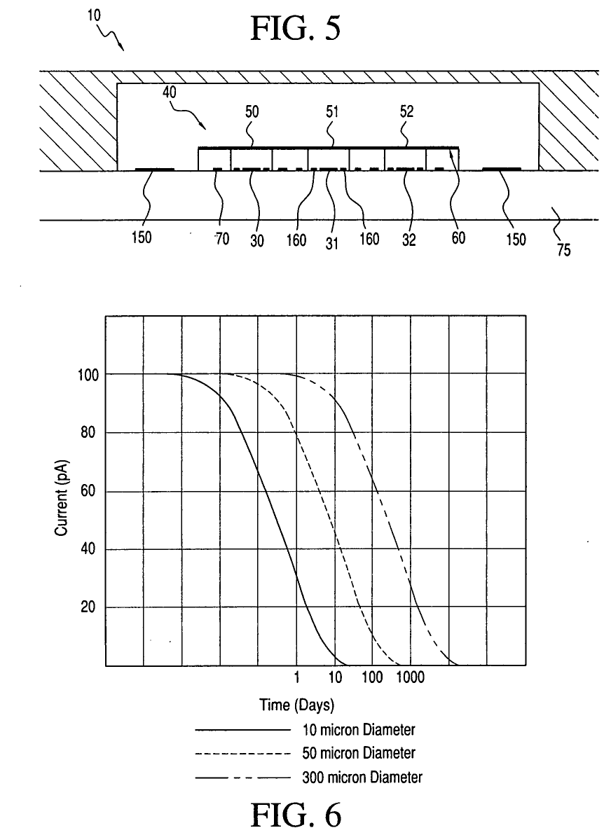

To produce an electrolyte current through pores 80, system 10 further includes a reference electrode 150 that is placed at a convenient location in analyte chamber 40 as shown in FIG. 5. For example placing both sensing and reference electrodes 30, 150 on electronics layer 75, simplifies the electrical interconnection of system 10 to data acquisition and recording electronics (not shown). Together, sensing chamber 50, region 78 of barrier 60 containing pore 80, and sensing electrode 30 make up a single sensing unit 20. The sensing and reference electrodes are either resistively (Faradaic) or capacitively coupled to the electrolyte medium of system 10. A resistive electrode has the benefit of direct current (DC) coupling, but the disadvantage of involving a corrosion reaction in which the electrode itself dissolves into the electrolyte medium. In contrast, a capacitive electrode does not undergo ion exchange with the electrolyte medium and so does not corrode. When utilizing a capacitive electrode, it is necessary to make the electrical current passing through pore 80 alternating current (AC). This has the further benefit that reversing the direction of ionic flow through pore 80 prevents buildup of ion concentration and electrostatic charge in sensing chamber 50, as discussed below. It should be noted that AC drive may also be used with resistive electrodes, and if desired, both capacitive and resistive electrodes, shown for example by 31 and 160 in sensing chamber 51 of FIG. 5, are incorporated into sensing chamber 50 in order to permit the advantages and disadvantages to be traded in actual operations.

If unidirectional DC pore current is applied, there will be a steady ion concentration change in sensing chamber 50. Such a concentration change causes a Nernst potential to develop across membrane 60 that acts to oppose the electric field that drives the pore current. The magnitude of the Nernst potential depends on the amount of time the pore current has flowed plus the initial electrolyte medium ion concentration. The pore current is shown as a function of time for different sensing chamber volumes in FIG. 6. As depicted in FIG. 6, for fixed driving voltage, the current is reduced to half its value in about 5 days for a 50 μm diameter sensing chamber, but after only about 10 hours for a 10 μm diameter chamber.

As the size of sensing volume 55 is decreased, the concentration effects can become limiting. For a 5 nm×10 μm×10 μm sensing chamber with a pore current of singly charged ions of 100 pA and an initial concentration of 0.1 M, the Nernst voltage rises to 29% of the driving voltage after 1 ms; after 10 ms it is 80%.

One method to counter the build-up of Nernst potential is to increase the voltage applied across pore 80. The voltage required is set by monitoring the pore current to ensure a constant current. However, this method is limited in that it may require a means to apply significant voltages (>10 V) for the operational lifetime of sensing elements 20, 21, 22 to be extended significantly. As discussed in international patent application PCT/US2005/026181 entitled “Method and Apparatus for Sensing a Time Varying Current Through an Ion Channel” filed Jul. 22, 2005, incorporated herein by reference, capacitive electrodes coupled to an AC pore current are used to address the problems associated with Nernst potentials and quasi-electrostatic voltages. In addition to reversing the pore current direction at frequencies much lower than the pore signal frequency, it is also possible to drive the pore current at frequencies much higher than the pore signal frequency and then to recover the time dependence of the pore signal by demodulating this carrier frequency, as discussed below.

Electrostatic buildup of the net charge associated with the ions in the electrolyte medium is a possible concern. The electrical capacitance of sensing volume 55 is dominated by the capacitance across the barrier region 78 to analyte chamber 40 and to sensing electrode 30. As a result, although different system configurations may have widely different sensing volumes 55, they have substantially the same capacitance. If unbalanced charged ions accumulate within electrolyte volume 55, the voltage with respect to analyte chamber 40 (i.e., across the pore) is determined by this sensing volume capacitance. For a capacitance of 10 pico-Farads (pF) and an ion current of 100 pA, the sensing chamber voltage (i.e. relative to the analyte chamber) after 1 ms is 10 milli-volts (mV).

Thus, for a unidirectional pore current, as sensing volume 55 is made smaller there is an inherent trade-off between system sensitivity, which increases owing to a smaller analyte chamber, and operational lifetime. The smaller, and so more sensitive, system 10 becomes, the less time it can operate. For system 10 when it uses a unidirectional current and is limited in size by sensing chamber 50, a preferred size for sensing chamber 50 is in the range of 50 μm to 300 μm in diameter with a depth in the range of 10 μm to 300 μm.

If AC current is utilized, the time average of the pore current is zero and so concentration effects are avoided. A down side is that the average electrophoretic force produced by the voltage difference between the sensing and reference electrodes 30, 150 is also zero. This is addressed by tailoring the AC waveform to optimize the flow of analyte to pore 80. In one example, an applied electric field is maintained at a relatively low level for a period of time to allow an analyte to enter pore 80, and is then reversed to a higher level for a correspondingly short period of time to balance the net ion flow into associated sensing chamber 50. After the larger reversing period the electric field is turned off to allow the analyte distribution to reach equilibrium in the electrolytic medium via diffusion while no net current of electrolyte ions flows into pore 80.

There are two primary ways to implement an AC measurement of the current through pore 80. The first method is to drive a current via a separate electrode system and use an independent sensing electrode 160 as best seen in FIG. 5 to measure the build-up of voltage in sensing chamber 50 as shown in FIG. 6. The second method is to utilize a high frequency (1 kHz to 100 kHz) probe current to measure the impedance of pore 80 on a short time scale compared to the response time of pore 80. The first method (voltage sensing method) is described in PCT/US2005/026181. The second method (impedance sensing method) relies on modulating the pore current at relatively high frequency and then measuring the change in the current that flows depending on the pore resistance. For example, to probe events in the order of 0.1 ms, a frequency on the order of 10 kHz is preferable. The impedance probe configuration allows the use of a single electrode in the sensing volume.

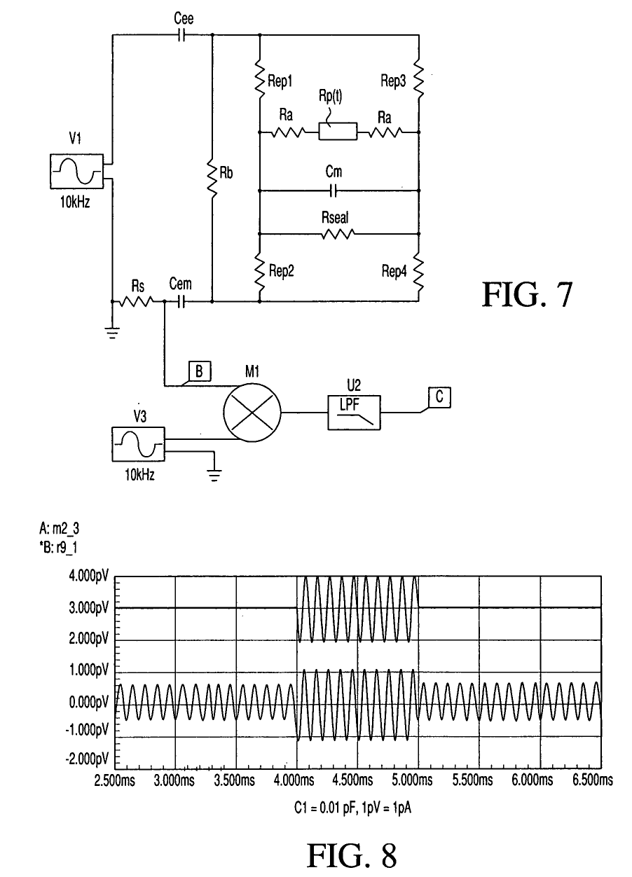

An example of a circuit for the impedance sensing method described above is shown in FIG. 7. FIG. 7 shows the direct electrolyte medium resistance Rb between sensing electrode 30 and reference electrode 150 and the membrane capacitance Cm associated with region 78. A signal is read out as the voltage across a current sensing resistor Rs at point B. The signal at point B is demodulated with a mixer M1 and an oscillator V3. The high frequency components of the signal are then filtered off with a low-pass filter U2.

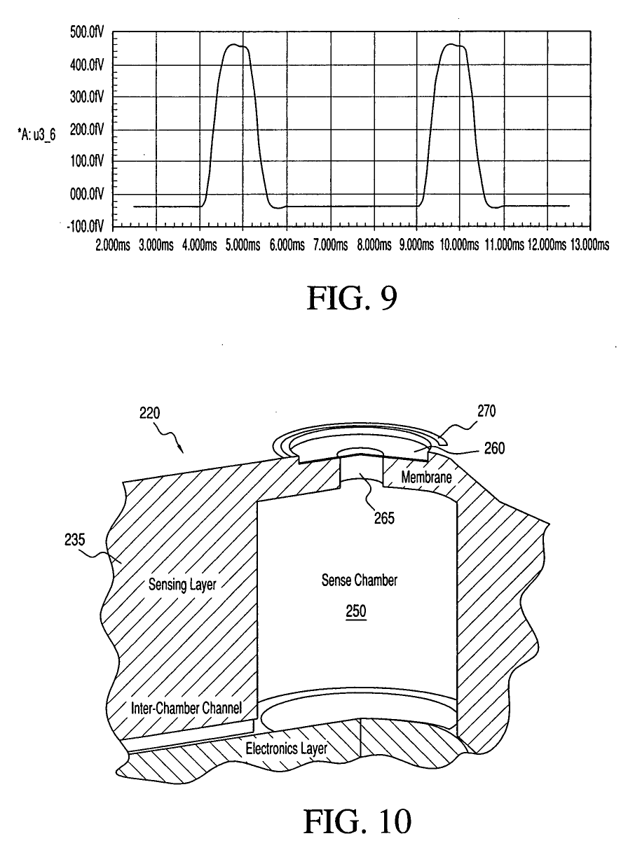

A simulated signal of the current modulation generated by the pore switching for the circuit of FIG. 7 is shown in FIG. 8 [the pore current is offset by 3 pico-Volts (pV) for clarity]. The pore current modulates between nearly zero to a maximum of 1 pico-Ampere (pA), giving a change in source current of about a factor of 2. The output from the demodulated signal after a 4-pole Bessel low-pass filter is shown in FIG. 9. The signal scales linearly for different pore currents and gains.

The impedance sensing method has the important property that the demodulated signal depicted in FIG. 9 is independent of the membrane capacitance. However, the ratio of the pore-open to pore-closed signal prior to demodulation has a significant dependence on the resistance Rb depicted in FIG. 7. Preferably, Rb is greater than 100 mega-ohms (MΩ). For example, for a pore current of 100 pApp (pico-ampers peak to peak), an Rb value of 100 MΩ gives 5 pApp of modulation current and a noise of 0.485 pApp; resulting in a signal-to-noise ratio of about 10.

A further aspect of the present invention is to measure two orthogonal components of the modulated pore response with respect to the applied oscillating pore current. This allows improved measurement of the spectral density of resistance fluctuations without explicit determination of other sources of noise in the readout system. To apply this method to measure the time-varying resistance of a pore the spectrum, over short overlapping time intervals, is computed and analyzed for the change in spectral energy at the frequency of the transition between high and low conductance states.

Sensing and reference electrodes 30 and 150, used to drive current through pore 80, also provide an electrophoretic force on analyte molecules in the electrolyte medium if the analyte molecules are charged, or through the electroosmotic force created with ion flow within system 10. One advantage of the compact system design of the present invention is that electric fields produced in electrolyte medium within system 10 may be much larger than those present in the prior art. For example, when 1 volt (V) is applied over a distance of 100 μm, the electric field is 10⁴ volts per meter (V/m). Thus, the electric fields created in electrolyte medium within system 10 may be greatly increased over those commonly used in the prior art.

Additional electrodes may be added to provide further electrostatic control. Preferably, around sensing volume 50 is conducting control ring 70. The potential of ring 70 is controlled to provide an electrophoretic force to attract or repel the analyte towards sensing volume 55 in the event that the analyte is charged. Alternatively, the potential of ring 70 is controlled by feedback to minimize coupling of the sensing electrode to stray potentials to improve sensitivity as taught by international patent application by Hibbs et al. entitled “System for Measuring the Electric Potential of a Voltage Source,” filed Sep. 22, 2005, incorporated herein by reference.

A further use of control ring 70 is to enable a specific pore 80 to be directed to a specific element 20 of array 37). Pore 80 must have a net charge or be tagged with a charge group in the manner known to those skilled in the art, so the potential of ring 70 is preferably set to attract or repel the desired pores. Once pore 80 is inserted, a DC potential is applied to ring 70 to anchor pore 80 within membrane 60. The electric field method is much simpler than techniques for accomplishing the directed insertion of a particular protein pore into a particular sensing unit via a complex microfluidic system with the ability to address individual sensing elements 20, 21, 22. An alternate method to determine the array location of a specific pore 80 is to apply the analyte detected by pore 80 and to observe which pore or pores give the expected response. Further with appropriate tagging, an optical means can be used to determine the location of individual sensing units.

The elements so described are for use with pores of all known types and the two paradigm barrier configurations. Further, the ability to utilize very small sensing volumes lends the invention to applications with future barrier and pore configurations, and the system should not be considered specific to a particular form of either. The use of the invention and specific additions to it for use with suspended and supported barrier configurations are discussed below.

### Suspended Configuration

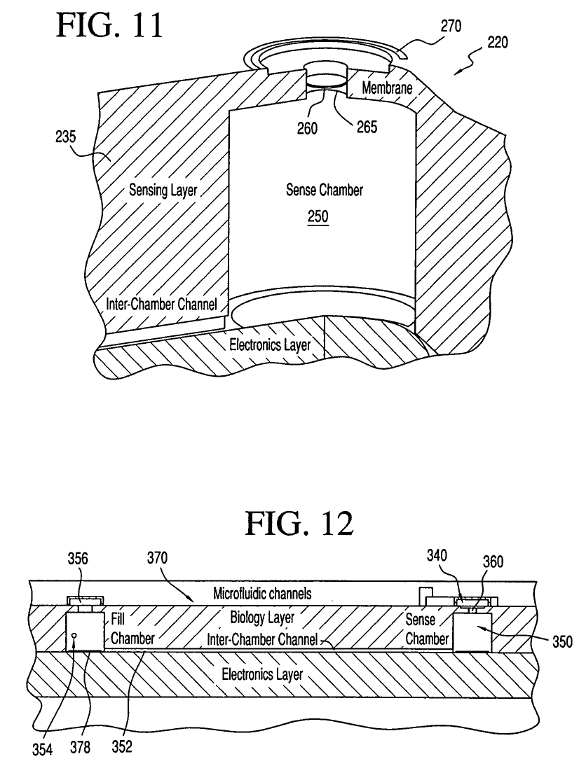

With initial reference to FIG. 10, a sensing element 220 is shown in a suspended configuration. In the preferred embodiment, a substrate 235 is formed with a sensing chamber 250 located therein. Chamber 250 is covered with a membrane 260 formed over an orifice 265. In some cases, such as for a bilayer lipid membrane, membrane 260 might form within the diameter of orifice 265 or hole as shown in FIG. 11. In all cases, the pore is within the opening provided by the orifice. FIGS. 10 and 11 show control ring 270 on the upper surface of the sensing layer 235.

A complete suspended membrane sensing system 10 of the present invention is depicted in FIG. 12 with an analyte chamber 340. As can be seen, sensing chamber 350 is connected via the narrow interchamber channel 352 to fill chamber 354. Fill chamber 354 is connected to analyte chamber 340 via a channel 356 to provide a means to balance the pressure across a sense chamber barrier or membrane 360 and thereby minimize vibration effects on system 10. Additionally, interchamber channel 352 provides a means to fill sensing chamber 350 with an electrolyte medium in the case that orifice 365 is very small and allows only a very small flow rate. Further interchamber channel 352 provides a means to raise and lower fluid levels in order to aid in fabricating a bilayer lipid membrane 360.

Interchamber channel 352 is made as long and as small in cross-section as possible in order to maximize the electrical impedance of the path from sensing chamber 350 to analyte chamber 340 via fluidics layer 370. This path effectively shorts the electrical impedance of membrane 360 and is therefore important in controlling the system's electrical properties. It is well known in the art that the membrane impedance in a suspended membrane system, excluding the pore, must be of order 1 giga-ohm (GΩ) and preferably higher to permit robust measurement. To increase the net impedance of interchamber channel 352 over the frequency range of interest, a voltage-controlled electrode 378 is placed in fill chamber 354 and maintained at the voltage of sensing chamber 350 by feedback. Simple analysis indicates that this method permits a factor of 100 increase in the impedance of interchamber channel 352.

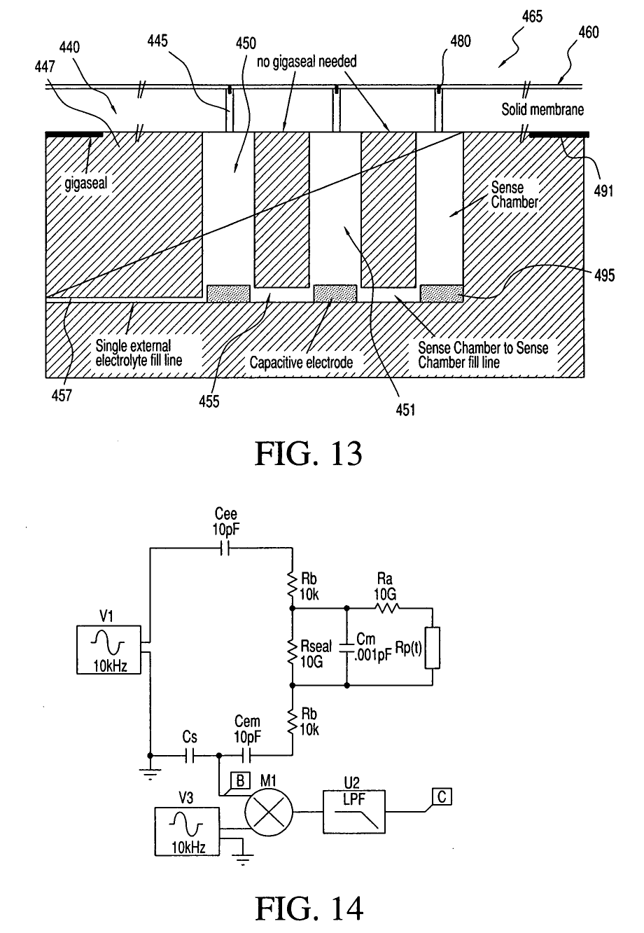

In FIG. 13 a layer 440 with through holes 445 is bonded to a substrate 447 that defines sensing chambers 450, 451. Membrane 460 is formed over second layer 440. To minimize the volume of analyte chamber 465, multiple sensing chambers 450, 451 are be coupled together by short fluidic paths 455 and a single interchamber channel 457 and fill chamber (not shown) used for all sensing chambers 450, 451. Otherwise, the addition of multiple interchamber channels requires an increase in the spacing between the sensing elements. Even if the interchamber channels themselves are very narrow (e.g. <10 μm), practical fabrication issues associated with reliably sealing the channels with gig Ohm level isolation from other elements means a relatively large separation between sensing chambers is needed. This extra space leads to an increase in the volume of the analyte chamber 40, and a corresponding reduction in sensitivity of system 10.

However, connecting multiple sensing chambers by a fluidic path does not work for the simple pore and membrane configuration described in the prior art because many protein pores of interest are usually in the open state with a conductance as high as 1 nano-siemen (nS) or a resistance in the order of 1 GΩ. Thus connecting one sensing chamber 450 to another 451 provides an electrical path of 1 GΩ to the analyte chamber 440 in parallel with a pore of interest. For an array of ten sensing units, the net short of an individual pore 480 by the other sensing units would be in the order of 100 mega-ohms (MΩ), making single sensing unit recording unfeasible. For 1000 elements, the short would be 1 MΩ.

To reduce the shorting effect of coupling sensing elements together, holes 485 are formed with a very narrow diameter as shown in FIG. 13, thus increasing the resistance in series with each associated pore 480. For example, the resistance of a 10 μm diameter hole 445 in a 6 μm second layer 440 is of the order 100 GΩ. To set the required series resistance, the combination of the cross-sectional area of the hole 445 and the electrolyte conductivity is set as desired. In any event, in order to provide an adequate isolation of pore 480, a resistance of hole 445 of at least n×1 GΩ is preferable, where n is the number of sensing elements in the array. With this controlled resistance, it is possible to connect multiple sensing chambers by short inter-element fluidic paths and use a single interchamber channel 457 to connect to an outside fluid reservoir.

Further because it is not necessary to isolate individual sensing chambers 450, 451 fluidically at the GΩ level, it is not necessary to seal second layer 440 at the top of each sensing chamber 450. Instead, it is only necessary to seal an outer perimeter of second layer 440 to provide overall isolation of the connected sensing chamber array from the analyte chamber. This seal is depicted in FIG. 13 at 491. In accordance with the most preferred embodiment of the invention, a single mechanical bond is used at the outer edge of second layer 440, permitting a relatively large width to be used for the bonding region, while simplifying the sealing process. More specifically, utilizing single large seal 491 instead of multiple small seals considerably simplifies system fabrication and minimizes the separation between sensing chambers 450, 451, thereby reducing the volume of analyte that must be introduced into the analyte chamber. In accordance with the invention, inter-element channel 445 has a much greater resistance than the resistance along a single sensing chamber 450, ensuring that most of the current passing through a particular pore 480 arrives at that pore's associated electrode 495, thereby allowing identification of the activity of a single pore 480.

Typically, resistance in series with a pore in suspended membrane and patch-clamp systems is specifically avoided to minimize noise and maximize system bandwidth. The use of a very small area of suspended barrier across hole 445 in the present invention reduces this requirement somewhat. For example, the capacitance in parallel with a pore in a 50 μm bilayer lipid membrane is in the order of 100 pico-Farads (pF), while the capacitance in parallel with a pore in a 50 nano-meter (nm) diameter bilayer lipid membrane is in the order of 0.01 fempto-Farad (fF). However, the increase in resistance is further overcome by utilizing a capacitive readout scheme in which the electrical potential of the electrolyte medium used in sensing chamber 450 is measured by an electrode 495 that couples to the electrolyte medium in a capacitive, rather than a resistive, manner. The impedances of capacitive electrode 495 and its associated first-stage amplifier are high, and therefore a high resistance of hole 445 in series with a given pore 480 has a minimal effect.

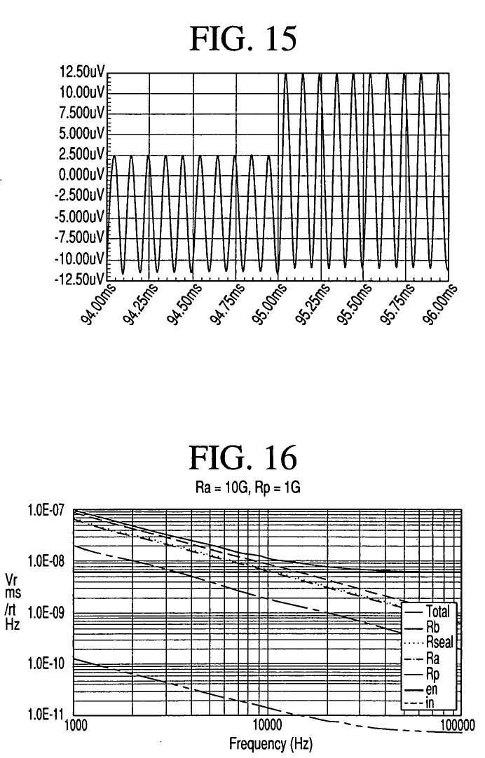

A model of a circuit used to calculate dynamic system response in the present invention is depicted in FIG. 14. As illustrated, a channel resistance Ra in the order of 10 GΩ is deliberately added via the short fluid path 455 depicted in FIG. 13. A simulated response for an exemplary AC modulation and demodulation impedance probe method utilizing the circuit model of FIG. 14 is shown in FIG. 15. Membrane capacitance (Cm) was set to 1 fF to allow for the effect of stray capacitance. Principal points taken along the model circuit are indicated in FIG. 14 as points B and C. Point B shows a signal that is demodulated with a mixer M1 and an oscillator V3. Point C shows the signal after being demodulated and filtered through a low-pass filter (LPF) at U2. The modulated input signal measured at point B before demodulation is shown in FIG. 15. The switching of the pore state is clearly visible even with the addition of the extra 10 GΩ access resistance from short fluid path 455. This signal is demodulated to produce a signal equivalent to that shown in FIG. 9.

The calculated equivalent voltage noise for all components when a pore is in an open state (Rp=1 GΩ) is shown in FIG. 16. The noise in a closed-pore state is lower, and the contribution from the added interchamber channel resistance is negligible compared to the impedance of the closed-pore state. The projected signal, noise and signal-to-noise ratio with and without the added resistance for an applied pore current of 0.707 pAᵣₘₛ for a pore that switches between resistance states of 1 GΩ (open) and 300 GΩ (closed) are shown in Table 1.

TABLE 1
Summary of System Simulation for an Added Series Resistance

| Rp | Ra | 1 kHz BW | Signal | Mod Index | |
|---|---|---|---|---|---|
| (GΩ) | (GΩ) | (uVrms) | (uVrms) | (%) | SNR* |
| 1 | 0.2 | 0.98 | 4.19 | 86.8 | 3.72 |
| 300 | 0.2 | 0.43 | 0.55 | NA | NA |
| 1 | 10 | 0.51 | 8.28 | 39.9 | 6.43 |
| 300 | 10 | 0.43 | 4.98 | NA | NA |

*Noise based on open-pore state

In Table 1, the noise in a 1 kHz bandwidth was obtained by integrating the noise spectrum from 9 kHz to 11 kHz and is the equivalent of noise measured at point B in FIG. 14. The signal level is taken as the amplitude of the 10 kHz source at point B for the different pore states. As can be seen from Table 1, adding a high resistance in series with the pore improves the system signal-to-noise ratio by a factor of 2, in addition to providing the ability to couple sensing chambers together in an array

### Supported Configuration

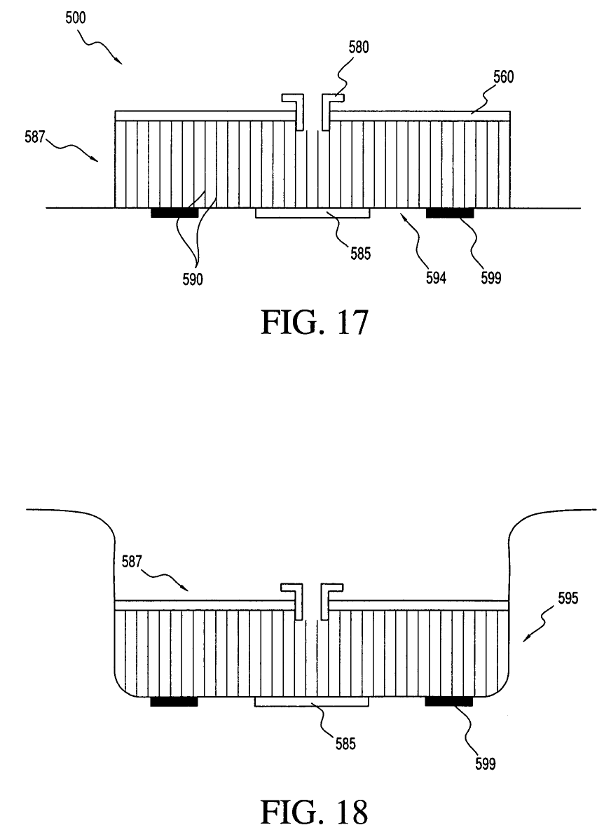

In the supported configuration, the preferred embodiment is a system 500 that includes a membrane 560, such as a bilayer lipid membrane, with a pore 580 therein, supported by a continuous underlayer, made of a polymer, a cushion of water or some other suitable material. In contrast with the suspended membrane configuration, the underlayer does not include a hole to enable inclusion of pore 580 and projection of pore 580 through membrane 560, but rather is a material with sufficient fluidity or elasticity to accommodate the body of the pore. In the supported configuration, the underlayer defines the sensing chamber as depicted in FIG. 17.

A principal design feature of supported membrane system 500 is the isolation of a sensing electrode 585 from electrolyte medium of an analyte chamber 587. Isolation of sensing electrode 585 is preferably improved by making membrane 560 overlap sensing electrode 585, thus increasing the length of the path between sensing electrode 585 and the electrolyte in analyte chamber 587. Analysis suggests that as the size of the membrane is increased, the direct resistance of sensing electrode 585 to analyte chamber 587 (i.e., not via pore 580) stabilizes at about 10 times the value found when membrane 560 equals the sensing electrode 585 in size. To approximate this limit, the diameter of membrane 560 is preferably in the order of five times the diameter of sensing electrode 585. For a sensing electrode of diameter 1 μm, the limiting (shunt) resistance is about 5 mega-ohms (MΩ), and the smaller the sensing electrode, the higher this shunt resistance. Thus, it is difficult to achieve a gigaseal simply by increasing the diameter of membrane 560. Further increasing the lateral overlap has a direct effect on the size of the analyte chamber 587, and thus the sensitivity of system 10.

Isolation of sensing electrode 585 can also be improved by cross linking the polymer tethers 590 or otherwise changing the mechanism of membrane attachment to electronics layer 594 so as to seal the edge of membrane 560 about individual sensing electrodes 585. Preferably a group of polymer tethers 590 of precise chain length is bonded to electrode 585 and comprise the support for membrane 560. Additionally, a barrier of an insulating material 595 is preferably fabricated around the electrode 585 so as to prevent resistive contact between the electrolyte volume defined tethered region and analyte chamber 587 as shown in FIG. 18. As discussed above, a further method of isolating sensing electrode 585 from the lateral resistive path under membrane 560 is to set the potential of the control ring 599 using feedback from sensing electrode 585.

### Array Size and Performance Considerations

The resulting array of sensing elements allows a user to obtain complex biological fingerprints (biofingerprints) that are characteristic of the presence of certain diseases, toxins, biological responses, etc. Such biofingerprints are not restricted to a single type of analyte.

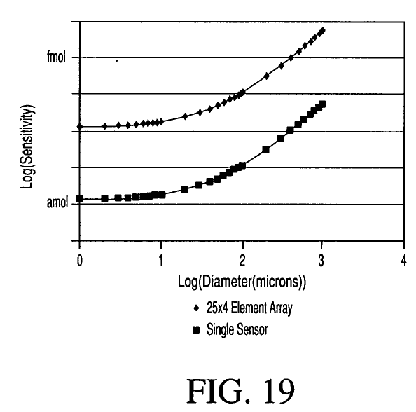

In most cases the system as described is limited by the diffusion rate of the analyte molecules in the electrolyte medium. The interaction rate of the analyte and pores is thus proportional to the analyte concentration. Thus, in the absence of other effects, a given desired response time requires a specific concentration as determined by the association constant of the desired analyte and the sensing element. For example, at an average association rate constant of 10⁸ (1/M-sec), a 10 nM solution is needed to provide a rapid (1 second) response time. Given this relationship, the absolute amount of analyte that is detected in a reasonable time period is set by the volume of the analyte chamber. This chamber preferably covers the entire sensing array and so is determined by the number of sensing units, their separation from one another, and their individual size. Assuming an inter element separation of 50 μm, and 25×4 sensing units in an array, the relationship between the maximum sensing unit lateral dimension and the resulting system sensitivity for a 1 nM analyte is shown in FIG. 19.

Thus, for a sensing element dimension of 100 μm, the sensitivity of a single sensing unit is projected to be in the order of 1 atto-mol (amol) and 100 amol for a 100-unit array. For a supported membrane as described by the preferred embodiment, it may be possible to reach a lateral size as small as 10 μm with a resulting sensitivity in the order of 0.2 amol for a single sensing unit and 2 amol for a 100 unit array.

This projection does not assume a reduction in the acceptable analyte concentration from electrophoresis. For a reduction of a factor of 10 in response time due to electrophoretic delivery of the analyte, the required concentration could be reduced by a factor of 10 leading to a corresponding improvement in sensitivity.

The particular construction of the sensing systems of the present invention enables construction of each sensing system on a single chip, glass or other suitable substrate, without the use of complex addressable microfluidics. The use of AC readout enables very small sensing element volumes leading to extremely high array sensitivity. The use of a general membrane architecture provides utilization of a wide range of pores. This flexibility allows rapid change of the composition of the sensing array by utilizing different pores. In providing these benefits, the invention efficiently bridges the gap between biological sensing capabilities at the nanometer scale and modern microelectronics at the micron scale.

Although described with reference to a preferred embodiment of the invention, it should be readily understood that various changes and/or modifications can be made to the invention without departing from the spirit thereof. In general, the invention is only intended to be limited by the scope of the following claims.

I/We claim:

1. A sensing system for identifying biological entities comprising:
an analyte chamber defining a volume of electrolyte containing an analyte;
a sensing element having an associated barrier, a sensing volume containing an electrolyte and a sensing electrode located within said sensing volume;
a reference electrode located within the analyte chamber;
a source for inducing an oscillating current to flow between the analyte chamber and the sensing volume; and
a readout circuit and a demodulator for determining a time variation of the current between the analyte chamber and the sensing volume.

2. The sensing system according to claim 1, wherein the sensing electrode has a predominantly capacitive coupling to the electrolyte within the sensing volume.

3. The sensing system according to claim 1, wherein the reference electrode has a predominantly capacitive coupling to the electrolyte within the analyte chamber.

4. The sensing system according to claim 1, wherein the sensing electrode has a predominantly resistive coupling to the electrolyte within the sensing volume.

5. The sensing system according to claim 1, wherein the reference electrode has a predominantly resistive coupling to the electrolyte within the analyte chamber.

6. The sensing system according to claim 1, further comprising: a separate electrode located within the analyte chamber to provide an electrical ground for use with the readout circuit.

7. The sensing system according to claim 1, further comprising: a substrate provided along the barrier, at least a portion of the substrate forming part of the sensing element.

8. The sensing system according to claim 1, wherein the barrier is a bilayer lipid membrane.

9. The sensing system according to claim 1, wherein the barrier is polydimethylsiloxane.

10. The sensing system according to claim 1, further comprising: a pore spanning the barrier.

11. The sensing system according to claim 10, wherein the pore is selected from the group consisting of a protein pore, an ion channel and a transporter.

12. The sensing system according to claim 10, wherein the pore constitutes a through hole provided in the barrier.

13. The sensing system according to claim 1, wherein the barrier has an area that overlaps an area of the sensing electrode by a factor of at least three.

14. The sensing system according to claim 1, further comprising: a substantially annular electrode located around the sensing element.

15. The sensing system according to claim 14, further comprising: means for controlling a voltage of the substantially annular electrode.

16. The sensing system according to claim 15, further comprising: means for increasing an electrical isolation of the sensing electrode from other parts of the sensing system.

17. The sensing system according to claim 15, further comprising: means for increasing a rate of arrival of analyte molecules at the pore.

18. The sensing system according to claim 15, wherein the voltage of the substantially annular electrode influences insertion of a specific pore in the membrane of the sensing electrode during fabrication of the sensing system.

19. The sensing system according claim 10, wherein the pore has attached a specific taggant.

20. The sensing system according to claim 1, wherein the area of the sensing volume in the plane of the substrate is less than 10,000 μm².

21. The sensing system according to claim 1, wherein the area of the sensing volume in the plane of the substrate is less than 1,000 μm².

22. The sensing system according to claim 1, further comprising: means for combining two orthogonal components of an output signal to reduce an effect of instrument noise on the sensing system.

23. The sensing system according to claim 1, wherein the barrier associated with the sensing element is suspended over a narrow channel of roughly constant cross-sectional area in a substantially solid material.

24. The sensing system according to claim 23, wherein both a diameter and a length of the narrow channel and the conductivity of the electrolyte are chosen to produce an electrical impedance of greater than 2 GΩ.

25. The sensing system according to claim 23, wherein a diameter of the narrow channel is greater than four times a diameter of the pore.

26. The sensing system according to claim 1, wherein a fundamental frequency of the oscillating current is greater than 1 kHz.

27. The sensing system according to claim 1, wherein the barrier has no more than five pores located therein.

28. The sensing system according to claim 1, further comprising: additional sensing elements arranged so that the sensing elements form an integrated array, with the readout circuit producing a bio-fingerprint of the analyte.

29. The sensing system according to claim 28, wherein the barrier spans two or more of the sensing elements.

30. The sensing system according to claim 28, wherein at least two of the sensing elements are designed to sense different analytes.

31. The sensing system according to claim 28, further comprising: a substantially annular electrode located around at least two of the sensing elements.

32. The sensing system according to claim 31, further comprising: means for controlling a voltage of the substantially annular electrode to improve performance of the sensing system.

33. The sensing system according to claim 28, further comprising: means for increasing an isolation of one of the sensing electrodes from other parts of the sensing system.

34. The sensing system according to claim 28, wherein a center-to-center spacing of the integrated array is less than 100 μm.

35. The sensing system according to claim 28, wherein the number of sensing elements in the integrated array is greater than 16.

36. The sensing system according to claim 28, wherein each of the sensing elements includes an associated sensing volume, with one or more of the sensing volumes being connected together by a narrow fluid channel, while a single narrow fill channel connects each sensing volume to the analyte chamber.

37. The sensing system according to claim 36, further comprising:
an electrode arranged in the fill channel; and
feedback means for controlling a voltage of the fill channel electrode to increase an electrical isolation of the sensing volumes connected to the fill channel from the analyte chamber.
